(19) United States
(12) Patent Application Publication
(10) Pub. No.: US 2015/0304105 A1
(43) Pub. Date: Oct. 22, 2015

(54) Methods and Apparatuses of Processing Sealed Data with Field Programmable Gate Array

(71) Applicants: Weidong Shi, Pearland, TX (US); Yang Lu, Pearland, TX (US); Lei Xu, Houston, TX (US)

(72) Inventors: Weidong Shi, Pearland, TX (US); Yang Lu, Pearland, TX (US); Lei Xu, Houston, TX (US)

(21) Appl. No.: 14/615,756

(22) Filed: Feb. 6, 2015

Related U.S. Application Data
(60) Provisional application No. 61/936,876, filed on Feb. 7, 2014.

(51) Int. Cl. H04L 9/08

(52) U.S. Cl. CPC H04L 9/0825

(57) ABSTRACT

The present invention describes a data processing apparatus comprising, at least one field-programmable gate array device, at least one transceiver, at least one storage device wherein said storage device stores at least one key, a key translator in the form of bitstream or reconfigurable circuit wherein said key translator can decrypt an encrypted key, a data sealer wherein said data sealer can encrypt data stored in the field-programmable gate array device or the electronic memory device, and a data unsealer wherein said data unsealer can decrypt data stored in the field-programmable gate array device or the electronic memory device.

This application claims the benefit of U.S. Provisional Application No. 61/936,876, filed on Feb. 7, 2014.

### BACKGROUND OF THE INVENTION

### Field of the Invention

This invention relates to data processing apparatus operating on sealed data with field programmable gate array comprising key translator, data unsealer, and data sealer.

### BRIEF DESCRIPTION OF THE DRAWINGS

The invention may be better understood, and further advantages and uses thereof more readily apparent, when considered in view of the following detailed description of exemplary embodiments and examples, taken with the accompanying diagrams, in which:

FIG. 1(A) is a block diagram showing, in one exemplary embodiment of the present invention, components of a data processing apparatus;

FIG. 1(B) is a block diagram showing, in an alternative exemplary embodiment of the present invention, a key translator stored by a data processing apparatus as part of a bitstream;

FIG. 1(C) is a block diagram showing, in an exemplary embodiment of the present invention, a key generator contained in a data processing apparatus;

FIG. 1(D) is a block diagram showing, in an alternative embodiment of the present invention, a key generator stored by a data processing apparatus as part of a bitstream;

FIG. 2 is a block diagram showing, in one exemplary embodiment of the present invention, coupling of a data processing apparatus with a host;

FIG. 3 is a block diagram showing, in one exemplary embodiment of the present invention, a plurality of data processing apparatus coupled with a data processing manager;

FIG. 4 is a flow chart showing, in one exemplary embodiment of the present invention, the method of processing sealed data by a data processing apparatus;

FIG. 5 is a block diagram showing, in one exemplary embodiment of the present invention, a function evaluator and a pair of hash code and value; and

FIG. 6 is a block diagram showing, in one exemplary embodiment of the present invention, components of a bitstream.

While the patent invention shall now be described with reference to the embodiments shown in the drawings, it should be understood that the intention is not to limit the invention only to the particular embodiments shown but rather to cover alterations, modifications and equivalent arrangements possible within the scope of appended claims. Throughout this discussion that follows, it should be understood that the terms are used in the functional sense and not exclusively with reference to a specific embodiment, or implementation.

### DETAILED DESCRIPTION OF THE PREFERRED EMBODIMENTS

Discussion in this section is intended to provide a brief description of some exemplary embodiments of the present invention.

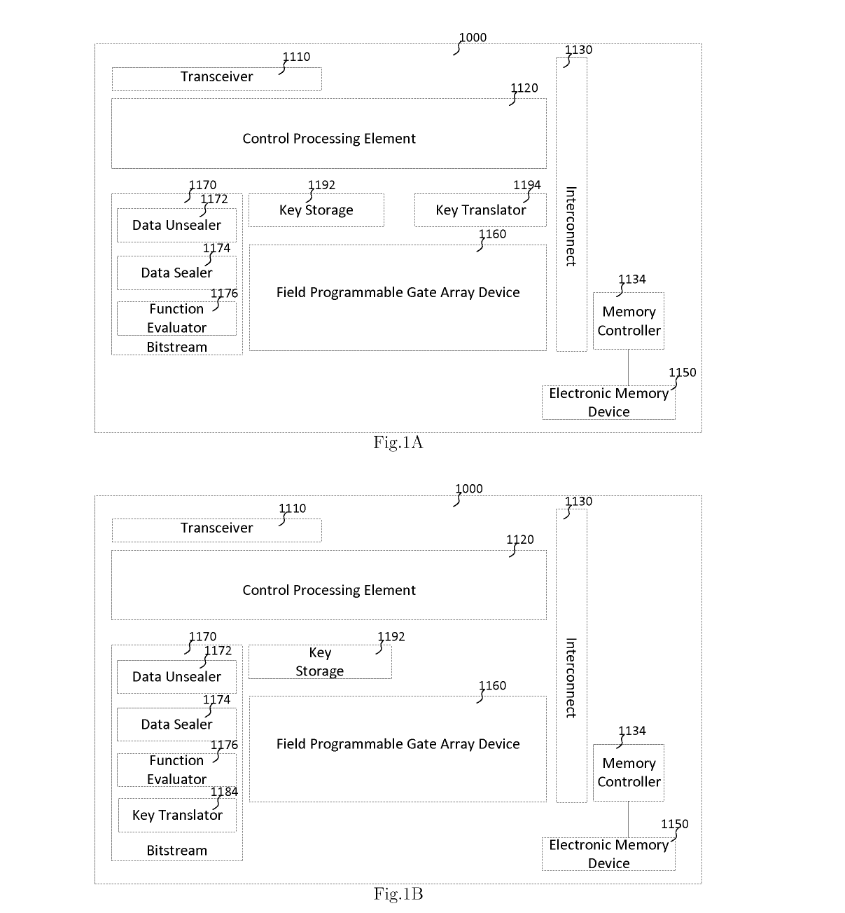

FIG. 1(A) is a block diagram showing, in one exemplary embodiment of the present invention, components of a data processing apparatus. A data processing apparatus (1000) can comprise, at least one field-programmable gate array device (1160), at least one transceiver (1110), at least one electronic memory device (1150), at least one storage device for storing one or a plurality of keys (1192), a key translator (1194), a data sealer (1174), and a data unsealer (1172).

A field-programmable gate array device (1160) is an integrated circuit designed to be configurable after manufacturing. A field-programmable gate array device can be configured or reconfigured to implement a digital circuit. This is achieved by loading configuration data to a field programmable gate array device. The configuration data is called bitstream. A bitstream can be stored in an electronic storage of a data processing apparatus. A bitstream can comprise configuration data of a digital circuit. After a field-programmable gate array device is configured to function as a digital circuit, the circuit is called reconfigurable circuit. It is worth pointing out that the present invention is not limited to any specific field-programmable gate array device of a particular vendor.

A transceiver (1110) (e.g, RF transceiver, or ethernet transceiver) is a device comprising both transmitter and receiver handling circuitry. A RF Transceiver uses RF (radio frequency) modules for data transmission.

Depending on the implementations, an embodiment of a data processing apparatus can comprise one or a plurality of transceivers (e.g., WiFi transceivers, or cellular transceivers, or ethernet transceivers).

An electronic storage device (1192) or an electronic memory device (1150) is any medium that can be used to record information electronically (e.g., volatile DRAM, or non-volatile storage, or solid state drive, or hard disk, or flash memory). In an exemplary embodiment, an electronic storage device can comprise non-volatile random access memory. A non-volatile random access memory retains its information when power is turned off (non-volatile). The memory can be integrated on-chip (e.g., non-volatile SRAMs, or on-chip flash memory) or it can be off-chip (e.g., flash memory, or ferroelectric RAM, or magnetoresistive random-access memory, or phase-change memory, or nano-RAM, or millipede memory, or resistive random access memory, or BBRAM) or integrated into a package.

An electronic memory device can couple with a field-programable gate array device through a memory controller (1134) and interconnect (1130).

In accordance with the present invention, a data processing apparatus can comprise an electronic storage device that can store one or a plurality of keys. A key is a piece of information that determines the functional output of a cryptographic algorithm or cipher. Depending on the implementation or choice of cryptographic design, a key can specify the particular transformation of plaintext into ciphertext, or vice versa during decryption. In further embodiments, a data processing apparatus can comprise one or a plurality of keys used in creating or verifying digital signatures or message authentication codes.

A key translator (1194) is a process of key recovery. It takes two inputs, one is a secret value, which is generally a private key from a public/private key pair, the other is transformed key, which is generally a cipher-text of a key that is encrypted with a public key from a public/private key pair. The output of key translator is the original key.

In an exemplary embodiment, a key translator can further comprise at least one finite field multiplier, or a finite field divider, or an elliptic curve point adder, or an elliptic curve scaler multiplier, or a lattice related operator.

Depending on the embodiments, a key translator can be implemented as an ASIC (application specific integrated circuit) component, or implemented as re-configurable circuit.

In some embodiments, a data processing apparatus (1000) can comprise a bitstream (1170) that further comprises re-configurable data to programm a field-programmable gate array device into a digital circuit that contains a key translator.

A sealer (1174) is a digital circuit that can transform digital data. It takes two inputs, one is a key, and the other is the data itself. The output of this process is a sealed data. Depending on the implementation, a sealer can seal data using any cryptographic approach (e.g., Twofish, or Serpent, or AES, or Blowfish, or CAST5, or RC4, or 3DES, or IDEA).

A sealer can be stored in a data processing apparatus as part of a bitstream.

An unsealer (1172) is a digital circuit that can transform digital data, and it can perform the reverse process of sealer. It takes two inputs, one is a key, and the other is the transformed data itself. The output of this process is a piece of unsealed data. Depending on the implementation, a unsealer can unseal data using any cryptographic approach (e.g., Twofish, or Serpent, or AES, or Blowfish, or CASTS, or RC4, or 3DES, or IDEA). A unsealer can be stored in a data processing apparatus as part of a bitstream.

In some exemplary embodiments, the sealed and/or unsealed data can be stored in an electronic memory device (e.g., DRAM, or SRAM, or non-volatile memory, or flash) of a data processing apparatus.

In some additional embodiments, a data processing apparatus can comprise a cryptographic hash unit (e.g., Gost, or Haval, or MD5, or Panama, or Ripemd, or SHA-1, or SHA-256, or SHA-512, or SHA-3, or Whirlpool). A cryptographic hash unit is a digital circuit that can compute hash function, which is any algorithm that maps data of arbitrary length to data of a fixed length.

A cryptographic hash unit can be stored in a data processing apparatus as part of a bitstream.

In some exemplary embodiments, a data processing apparatus can comprise one or a plurality of control processing elements (1120). A control processing element is an electronic circuit which executes computer programs. A control processing element can be implemented as system on a chip (SoC). A system on a chip or system on chip (SoC or SOC) is an integrated circuit (IC) that integrates components of a computer or other electronic system into a single chip. It may contain digital, or analog, or mixed-signal, or radio-frequency functions all on a single chip substrate.

In additional exemplary embodiments, a data processing apparatus can comprise one or a plurality of function evaluators (1176). A function evaluator is a digital circuit that can apply some algorithms on inputs to get the results. A function evaluator can be stored in a data processing apparatus as part of a bitstream.

A data processing apparatus can further comprise a key fetcher in the form of bitstream or reconfigurable logics. The key fetcher can fetch or receive a key.

FIG. 1(B) is a block diagram showing, in an alternative exemplary embodiment of the present invention, the key translator (1184) stored in a bitstream by a data processing apparatus.

FIG. 1(C) is a block diagram showing, in an exemplary embodiment of the present invention, a key generator (1198) contained in a data processing apparatus. Depending on the embodiments, a key generator can be implemented as an ASIC (application specific integrated circuit) component, or implemented as re-configurable circuit.

Depending on the embodiments, a key generator can generate one or a plurality of keys according to certain cryptographic approach (e.g., DiffieHellman key exchange protocol, or DSS, or ElGamal, or Various elliptic curve techniques, or Paillier crypto schemes, or RSA encryption approaches, or CramerShoup crypto schemes).

In some exemplary embodiments, a key generator can be instructed to generate one or a plurality of keys by the data processing apparatus or a user. The generated key can be stored in an electronic storage device of the data processing apparatus.

FIG. 1(D) is a block diagram showing, in an alternative embodiment of the present invention, a key generator (1188) stored by a data processing apparatus as part of a bitstream.

It is worth to point out that the described embodiments are only for illustration purpose. Equivalent embodiments may be readily apparent to those of ordinary skill in the art. The present invention should not be limited only to the described embodiments herein.

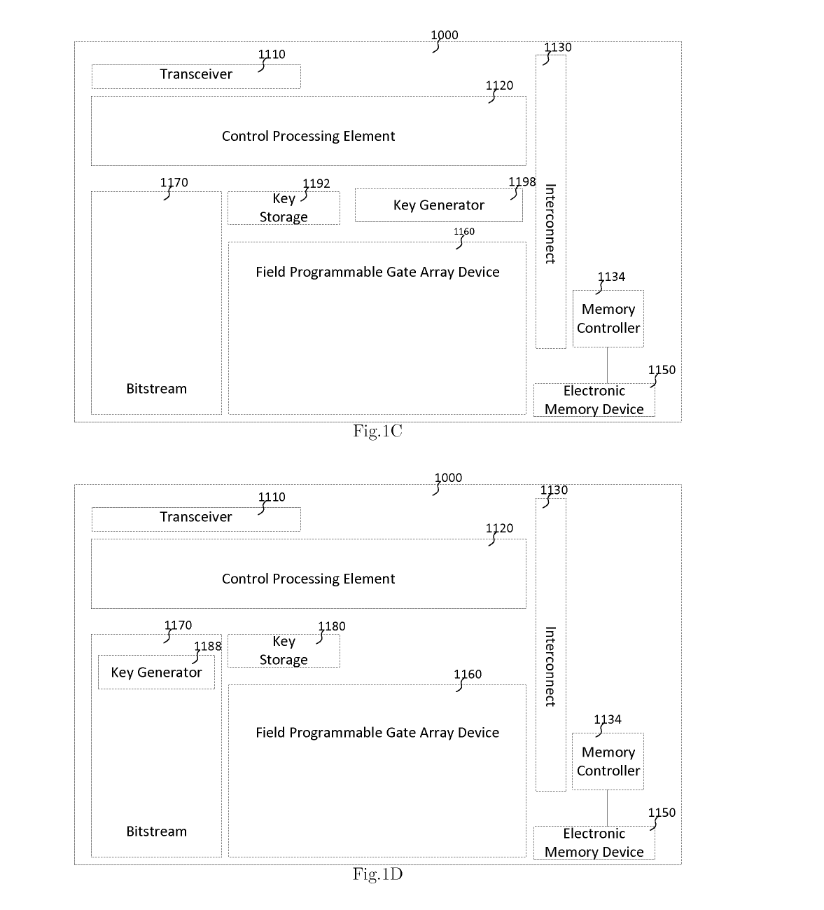

FIG. 2 is a block diagram showing, in one exemplary embodiment of the present invention, coupling of a data processing apparatus with a host (2000).

In some exemplary embodiments, a data processing apparatus can comprise a host bus (1114) (e.g., PCI, or PCI express, or AGP) that can couple a data processing apparatus with a host (2000) (e.g., a computer).

Depending on the embodiments, bitstream and/or data can be downloaded to a data processing apparatus from a host (2000) through the bus (1114).

It is worth to point out that the described embodiments are only for illustration purpose. Equivalent embodiments may be readily apparent to those of ordinary skill in the art. The present invention should not be limited only to the described embodiments herein.

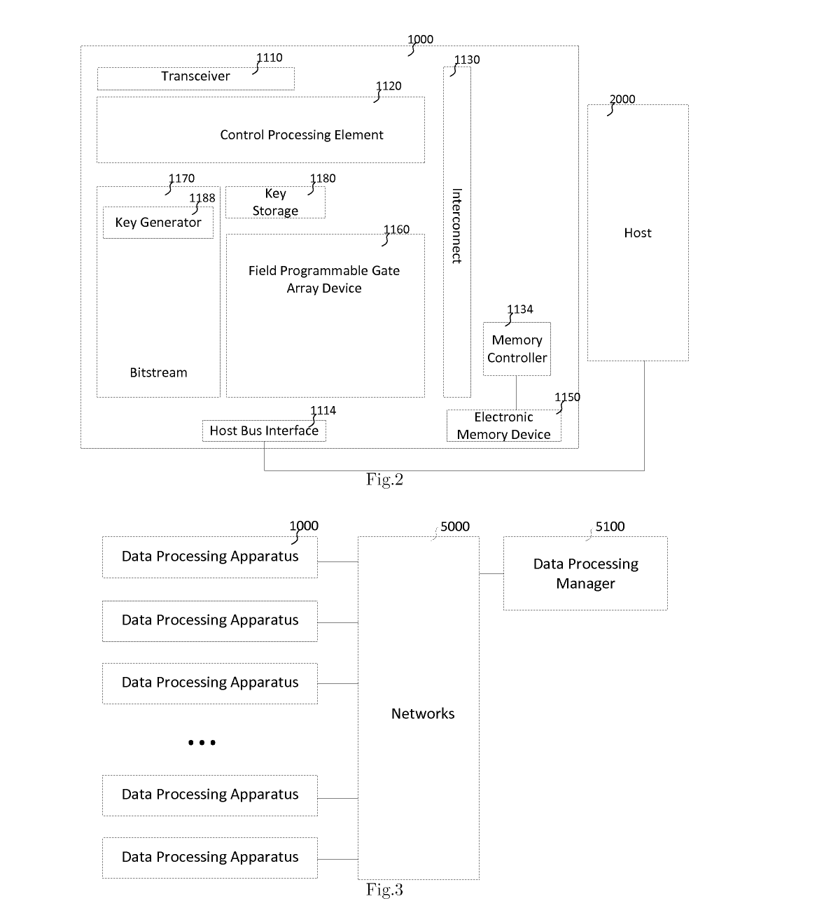

FIG. 3 is a block diagram showing, in one exemplary embodiment of the present invention, a plurality of data processing apparatuses coupled with a data processing manager. A data center can comprise a plurality of data processing apparatuses coupled by networks (5000) (e.g., local area network, or system area network).

In some exemplary embodiments, a data processing manager (5100) can select data processing apparatus (4110) and/or dispatch sealed data to the selected data processing apparatus.

In further embodiments, a data processing manager can apply load balancing or any data parallel processing approach to distribute sealed data to the data processing apparatuses.

It is worth to point out that the described embodiments are only for illustration purpose. Equivalent embodiments may be readily apparent to those of ordinary skill in the art. The present invention should not be limited only to the described embodiments herein.

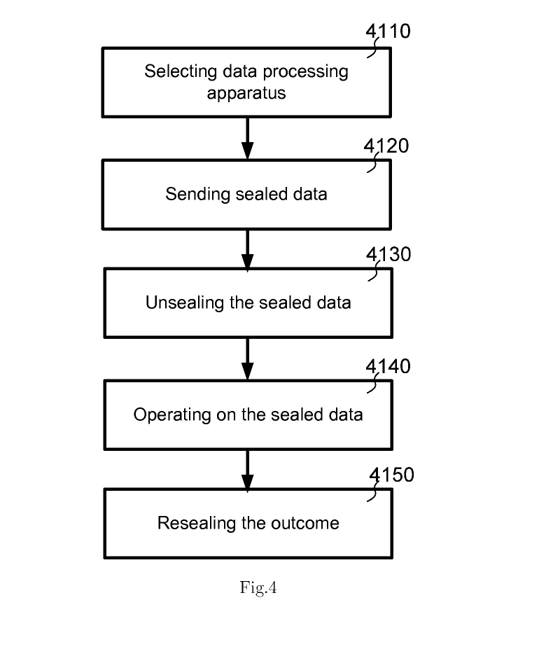

FIG. 4 is a flow chart showing, in one exemplary embodiment of the present invention, the method of processing sealed data by a data processing apparatus.

In an exemplary embodiment, for processing sealed data, a data processing apparatus can, store sealed data (4120) in an electronic memory device of the data processing apparatus, unseal the sealed data by the unsealer (4130), operate on the unsealed data (4140), and reseal the entire or a subset of the outcome of the operation by the data sealer (4150). In an additional embodiment, the resealed outcome is stored in the electronic memory device.

In some exemplary embodiments, a data processing apparatus can receive a sealed data key and unseal the sealed data key by the key translator.

Depending on the embodiment, a data key can be a key of any symmetric key encryption (e.g., Twofish, or Serpent, or AES, or Blowfish, or CAST5, or RC4, or 3DES, or IDEA).

In some exemplary embodiments, selecting data processing apparatus includes running a proxy re-encryption scheme.

In an exemplary embodiment, a proxy re-encryption scheme contains five algorithms, key generation , re-encryption key generation, encryption, re-encryption, and decryption. G₁ and G₂ are two groups of prime order q, and G₁×G₂→G₂ is a bilinear map, g is a generator of G₁. For key generation, a user A's key pair is (pk_{A}=g^{a}, sk_{A}=a). For re-encryption key generation, a user A generates a re-encryption key for user B by computing rk_{A→B}=g^{b/a}∈G₁. For encryption, to encrypt a message m∈G₂ under pk_{A}, output c_{A}=(g^{ak},mZ^{k}), where k is a random number. For re-encryption of cipher-text c_{A} with rk_{A→B}=g^{b/a}, compute e(g^{ak}, g^{b/a})=Z^{bk} and publish c_{B}=(Z^{bk}, mZ^{k}). For decryption of c_{b}=(α,β) with sk_{B}, compute m=β/α^{1/b}.

Depending on the embodiment, G₁ can be a group of elliptic curve points, and G₂ can be a cyclic subgroup of a finite field. A data key can be generated from an element of G₁ using a hash function. Sealing a key is achieved by running the encryption algorithm and take the key as the message. Resealing a key is achieved by re-encrypting the data key. Key translator uses decryption to unseal the data key.

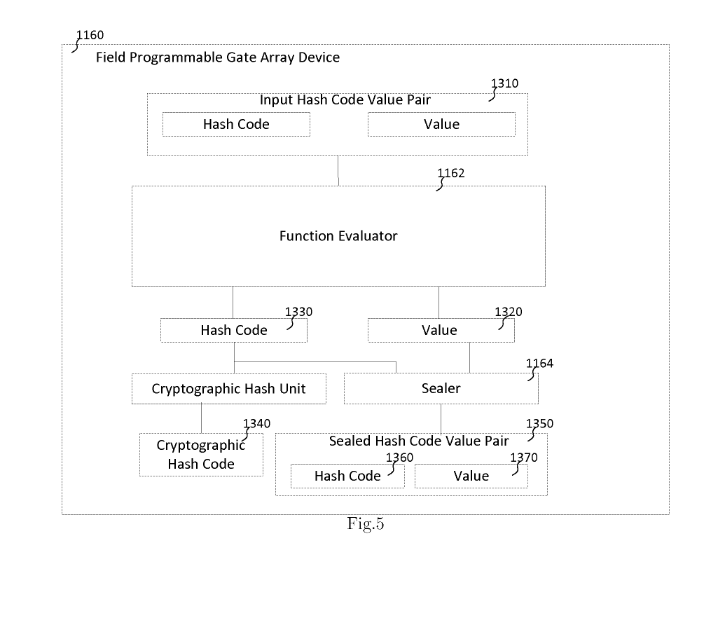

FIG. 5 is a block diagram showing, in one exemplary embodiment of the present invention, a function evaluator and a pair of hash code and value.

In an exemplary embodiment, a data processing apparatus can be applied to run MapReduce programming model. In this case, a data processing apparatus can run a custom mapper and/or reducer function. The mapper function and/or reducer function can be stored as part of a bitstream. The mapper function and/or reducer function can be implemented as digital circuit by configuring the field-programmable gate array device of a data processing apparatus.

In additional embodiments, the input hash code and value pair to a mapper function and/or reducer function of MapReduce can be sealed. To process the sealed data, a data processing apparatus, read an input pair of hash code and value (1310), create a new pair of hash code (1330) and value (1320) by evaluating a logic function (1162) (e.g., mapper function or reducer function), create a cryptographic hash code (1340) and seal the output pair of hash code and value (1164). The sealed output pair (1350) comprises the output hash code (1360) and the output value (1370). Furthermore, the data processing apparatus can store the outcome in the field programmable gate array or the electronic memory device of the data processing apparatus.

In further embodiments, a data processing apparatus can use a hash code unit (1166) to convert the hash code of the output pair of hash code and value to a cryptographic hash code.

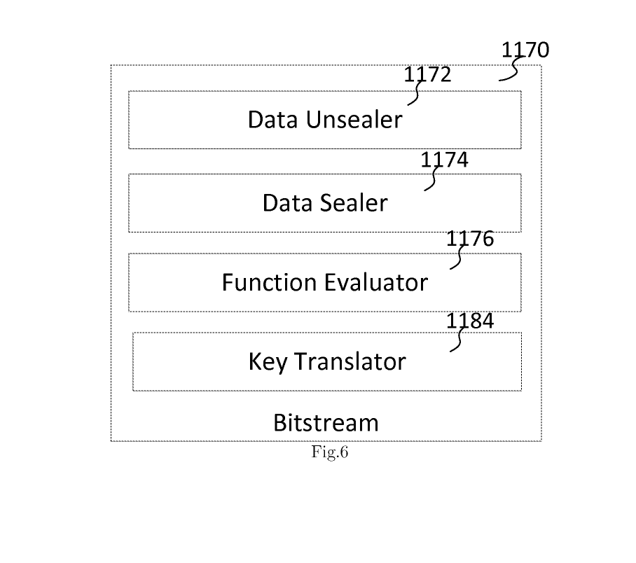

FIG. 6 is a block diagram showing, in one exemplary embodiment of the present invention, components of a bitstream.

In an exemplary embodiment, a vendor can distribute a bitstream for the type of data processing apparatuses shown in FIG. 1(A) to FIG. 1(D). A bitstream can comprise, a key (1186), a key translator (1184) that can decrypt an encrypted key, a data sealer (1174), a data unsealer (1172), and a function evaluator (1176).

In further exemplary embodiments, a function evaluator can comprise a pattern classifier. The pattern classifier contained in the bitstream can configure a field-programmable gate array device into a pattern classification circuit (e.g., bio-metric pattern match, or pattern recognition, or template match, or digital classifier).

In alternative exemplary embodiments, a function evaluator can comprise a signal processor. The signal processor contained in the bitstream can configure a field-programmable gate array device into a signal processing circuit (e.g., speech processing, or image processing, or image recognition, or speech to text, or image to text, or medical image processing, or acoustic processing, or multimedia transcoding, or data compression).

In alternative exemplary embodiments, a function evaluator can comprise a router. The router contained in the bitstream can configure a field-programmable gate array device into a network routing circuit (e.g., software defined router, or switch, or firewall, or network forward engine). When configured as a router, a data processing apparatus can comprise, one or a plurality of routing tables stored in the electronic memory of the data processing apparatus.

In alternative exemplary embodiments, a function evaluator can comprise a transaction processor. The transaction contained in the bitstream can configure a field-programmable gate array device into a transaction circuit (e.g., a payment processor, or a signature signing processor, or a certification verification processor, or an identity attestation processor).

In alternative exemplary embodiments, a function evaluator can comprise a database operator. The database operator contained in the bitstream can configure a field-programmable gate array device into a database operation circuit. Depending on the embodiments, sealed database data can be stored in a data processing apparatus. The database operator when configured as digital circuit on the field-programmable gate array can operate on the sealed data (e.g., insert, or find, or update, or delete data from a database stored in the electronic memory device). Depending on the implementation, a sealed database can comprise data organized as one or a plurality of tables.

It should be understood that there exists implementations of other variations and modifications of the invention and its various aspects, as may be readily apparent to those of ordinary skill in the art, and that the invention is not limited by the specific embodiments described herein.

What is claimed is:

1. A data processing apparatus, comprising, at least one field-programmable gate array device;
at least one transceiver;
at least one electronic memory device;
at least one storage device wherein said storage device stores at least one key;
a key translator in the form of bitstream or reconfigurable circuit wherein said key translator can decrypt an encrypted key;
a data sealer in the form of bitstream or reconfigurable circuit wherein said data sealer can encrypt data stored in the field-programmable gate array device or data stored in the electronic memory device; and
a data unsealer in the form of bitstream or reconfigurable circuit wherein said data unsealer can decrypt data stored in the field-programmable gate array device or data stored in the electronic memory device.

2. The apparatus in claim 1 further comprising a key generator in the form of bitstream or reconfigurable circuit.

3. The apparatus in claim 1 wherein the key translator further comprising at least one finite field multiplier, or a finite field divider, or an elliptic curve point adder, or an elliptic curve scaler multiplier, or an lattice related operator, in the form of bitstream or reconfigurable circuit.

4. The apparatus in claim 1 further comprising a key fetcher in the form of bitstream or reconfigurable logics wherein said key fetcher can fetch or receive a key.

5. The apparatus in claim 1 wherein the key is a private key of any public private key encryption approach.

6. The apparatus in claim 1 further comprising a cryptographic hash unit in the form of bitstream or reconfigurable circuit.

7. The apparatus in claim 1 further comprising a peripheral bus wherein said peripheral bus can couples said apparatus with a host.

8. The apparatus in claim 1 further comprising one or a plurality of control processing elements.

9. A method of operating on sealed data using a data processing apparatus wherein said apparatus comprising at least one field-programmable gate array device, at least one transceiver, at least one electronic memory device, at least one key translator in the form of bitstream or reconfigurable circuit wherein said key translator can decrypt an encrypted key, said method comprising,
selecting at least one data processing apparatus wherein said apparatus comprising, at least one field-programmable gate array device, at least one transceiver, at least one electronic memory device, at least one storage device wherein said storage device stores at least one key, a key translator wherein said key translator can decrypt an encrypted key, a data sealer wherein said data sealer can encrypt data stored in the field-programmable gate array device or data stored in the electronic memory device, and a data unsealer wherein said data unsealer can decrypt data stored in the field-programmable gate array device or data stored in the electronic memory device;
sending sealed data to the data processing apparatus wherein the sealed data is stored in the electronic memory device or stored in the field-programmable gate array device;
unsealing the sealed data by the unsealer and/or the field-programmable gate array device;
operating on the unsealed data by the field-programmable gate array device; and
resealing the entire or a subset of the outcome of the operation by the data sealer and/or the field-programmable gate array device wherein the re-sealed outcome is stored in the electronic memory device.

10. The method in claim 9 further comprising, sending a sealed data key to the data processing apparatus.

11. The method in claim 10 further comprising, unsealing the sealed data key by the key translator.

12. The method in claim 11 wherein the data key is a symmetric key.

13. The method of operating on unsealed data in claim 9 further comprising,
reading an input pair of hash code and value;
creating a new pair of hash code and value by evaluating a logic function by the field programmable array wherein said logic function operates on the input hash key and value pair;
creating a cryptographic hash code and sealing said new pair of hash code and value; and
storing the outcome in the field programmable array or in the electronic memory device.

14. The method of creating a cryptographic hash code in claim 13 further comprising, converting the hash code of the new pair of hash code and value to a cryptographic hash code by a cryptographic hash unit.

15. A bitstream apparatus wherein said bitstream can be applied to program a data processing apparatus wherein said data processing apparatus comprising, at least one field-programmable gate array device, at least one transceiver, at least one electronic memory device, at least one storage device wherein said storage device stores at least one key, said bitstream comprising, a key translator wherein said key translator can decrypt an encrypted key;
a data sealer wherein said data sealer can encrypt data stored in the field-programmable gate array device or data stored in the electronic memory device;
a data unsealer wherein said data unsealer can decrypt data stored in the field-programmable gate array device or data stored in the electronic memory device; and
a function evaluator.

16. The function evaluator in claim 15 further comprising, a pattern classifier.

17. The function evaluator in claim 15 further comprising, a router wherein said router can make switch and/or routing decisions by looking up a routing table.

18. The function evaluator in claim 15 further comprising, a signal processor.

19. The function evaluator in claim 15 further comprising, a transaction processor.

20. The function evaluator in claim 15 further comprising, a database operator wherein said database operator can insert, or find, or update, or delete data from a database stored in the electronic memory device wherein said database comprising data is organized as one or a plurality of tables.
